(19) United States
(12) Patent Application Publication
(10) Pub. No.: US 2012/0078739 A1
(43) Pub. Date: Mar. 29, 2012

(54) Electronic registration systems for tracking and/or identifying fraudulent gift cards purchased or linked to fraudulent item returns, and associated methods

(75) Inventor: Maridee Joy Maraz, Sammamish, WA (US)

(73) Assignee: Nintendo of America, Inc., Redmond, WA (US)

(21) Appl. No.: 12/923,484

(22) Filed: Sep. 23, 2010

(51) Int. Cl. G06Q 99/00; G06Q 20/00

(52) U.S. Cl. 705/21; 705/318

(57) ABSTRACT

The exemplary embodiments described herein relate to the field of electronic registration (ER) of purchased products and, more particularly, to an improved electronic registration system that enables the tracking and/or identifying of fraudulent gift cards that are purchased or linked to fraudulent item returns. In certain exemplary embodiments, transaction information for gift cards is stored in and/or connected to an ER database such that fraudulent activities associated with the gift card and/or items linked to the gift card may be tracked and/or identified—even potentially long after the gift card has been initially provided.

### TECHNICAL FIELD

The exemplary embodiments described herein relate to the field of electronic registration (ER) of purchased products and, more particularly, to an improved electronic registration system that enables the tracking and/or identifying of fraudulent gift cards that are purchased or linked to fraudulent item returns. In certain exemplary embodiments, transaction information for gift cards is stored in and/or connected to an ER database such that fraudulent activities associated with the gift card and/or items linked to the gift card may be tracked and/or identified—even potentially long after the gift card has been initially provided.

### BACKGROUND AND SUMMARY

Electronic registration (ER) of product transactions recently has become available for the purpose of reducing unauthorized returns of purchased products and/or unauthorized warranty repair on purchased products. Electronic product registrations systems provided for this purpose are disclosed in, for example, U.S. Pat. Nos. 5,978,774; 6,018,719; and 6,085,172, the disclosures of which are all incorporated by reference herein in their entirety. The electronic registration system relies on the use of a unique identifier, such as a serial number linked to a UPC (and/or RFID) or its equivalent, for each product that is purchased. The serial number is obtained at the point of sale for inclusion in a registration database, together with other information, such as a date of transaction. This database can then be accessed in connection with an attempted product return/warranty transaction for the purpose of determining if the product qualifies for return/warranty under applicable return/warranty criteria under which the product was originally sold. Such electronic systems may also be used in connection with repair and/or exchange transactions, in addition to returns, by enabling an accurate determination as to whether the product qualifies for any of these actions under the appropriate policies and criteria under which the product was originally sold.

The ER system uses pre-established return/repair policies and procedures that are programmed into the ER system so that the system can perform a check when a product is presented for return to determine if the product qualifies for return, replacement and/or warranty repair based on sales transaction information available in the ER system for the particular product at issue. Thus, known ER systems include a database of return qualification information (or warranty/replacement criteria) for various manufacturers and/or retailers which enables the system to make an accurate determination with respect to whether or not a product actually qualifies for return (or warranty/replacement) based on the appropriate criteria and at the time the product is actually presented for return. Such ER systems have greatly reduced improper and fraudulent returns and warranty claims.

While such ER systems have proven to be very useful in their current forms, additional improvements in the system are still desired to make such ER systems more flexible in operation and in order to benefit customers, retailers, and manufacturers. And although predefined and customizable return/warranty policies may be used with ER systems, further improvements to such ER systems would be desirable, e.g, when attempting to track and/or identify fraudulent gift cards that are purchased or linked to fraudulent item returns. Stores sometimes attempt to reduce the likelihood of fraud and maintain the value of a sale and goodwill or accepting an apparently problematic item by issuing a gift card, store credit, or the like. Unfortunately, however, despite these protective measures, retailers are currently victim to rampant return and gift card fraud.

There are a number of schemes that fraudsters use. For instance, a store may provide a gift card or other form of store credit when a person attempts to return an item. If the item was fraudulently procured (e.g., stolen), then fraud is committed because the person will otherwise receive the value associated with the product. Similar fraud may occur, for example, when a fraudster receives a gift card when exchanging for a gift card an item that does not qualify for return (e.g., because it is broken, has been tampered with, is a different but repackaged product, etc.), when a fraudster puts a brick or other heavy object in what appears to be originally-sealed packaging or simply returns appears to be originally-sealed packaging with no product inside, etc.

Some products are sold with gift or point cards, and unwitting or complicit store personnel may simply accept the return of the item without the gift or point card. Of course, the outright theft of gift cards also sometimes occurs.

Retail and/or other stores may not be able to immediately detect the fraud, e.g., because damage or tampering to the product is not immediately apparent, the replacement of the item with a phony or incorrect item or complete absence of the item may not be detected until the “item” is “re-sold,” or handled in the returns center or elsewhere in the reverse supply chain, etc. Thus, even though the fraud ultimately may be detected, it may be too late in the sense that the gift card has already been issued.

Fraudulently procured gift cards oftentimes are listed for sale on Internet auction sites, and honest consumers often buy them not knowing the gift cards were stolen and/or tied to stolen products. As a result, honest consumers unwittingly participate in retail fraud. Currently, such problems are believed to present multi-million dollar cost issues.

Thus, it will be appreciated that there is a need in the art for improved ER techniques that provide techniques for tracking and/or identifying fraudulent gift cards that are purchased or linked to fraudulent item returns.

One aspect of certain exemplary embodiments relates to techniques for tracking and/or identifying fraudulent gift cards that are purchased or linked to fraudulent item returns.

Another aspect of certain exemplary embodiments relates to techniques for giving retailers control over their gift cards, allowing them to track, update status, and deactivate value if the gift cards are determined to be linked to fraudulent product returns or other fraudulent tender.

According to certain exemplary embodiments, an electronic registration (ER) method for reducing the incidence of fraud in connection with a form of stored value in connection with an ER system comprising an ER database is provided. At the ER system, an indication that an item has been returned and that a form of stored value has been issued is received. In the ER database, a record of the return of the item is stored. A record of the issuance of the form of stored value is stored. The record of the issuance of the form of stored value is associated with the record of the return of the item. At the ER system, an indication that the item was returned fraudulently is received. Via the ER system, the form of stored value is flagged using the association of the record of the issuance of the form of stored value with the record of the return of the item.

According to certain exemplary embodiments, an electronic registration (ER) system is provided. A point-of-sale (POS) interface is configured to receive messages from and provide messages to a POS system. An ER database is provided. ER programmed logic circuitry is configured to: receive, via the interface, an indication that an item has been returned and that a form of stored value has been issued; store, in the ER database, a record of the return of the item; associate a previously-stored record of the issuance of the form of stored value with the record of the return of the item; receive an indication that the item was returned fraudulently; flag the form of stored value using the association of the record of the issuance of the form of stored value with the record of the return of the item.

In certain exemplary instances, the party that initially accepted the return and issued the form of stored value may be a retailer, and the retailer may be notified to deactivate the form of stored value. Various actions may be taken when an attempt to use the form of stored value is made. For instance, in certain exemplary instances, a notification that the transaction should not be completed may be provided.

According to certain exemplary embodiments, an electronic registration (ER) method for reducing the incidence of fraud in connection with a form of stored value in connection with an ER system comprising an ER database is provided. At the ER system, an indication that a form of stored value has been purchased is received. A record of the purchase of the form of stored value is stored. At the ER system, an indication that the form of stored value was purchased fraudulently is received. Via the ER system, the form of stored value is flagged as having been purchased fraudulently. When an attempt to use the form of stored value is made, a notification that the transaction should not be completed is provided. When an attempt to inquire via the Internet, customer service line or otherwise is made regarding the stored value, the system will provide a zero value response. For instance, many gift cards offer online “check my balance” services, toll-free numbers to check balances, and/or the like. These services may use the same database and in certain exemplary instances would also report back a zero balance to the inquirer on the flagged card. In addition, or in the alternative, a message may be reported back to the inquirer that the balance cannot be ascertained and must be brought to the store for assistance, etc.

According to certain exemplary embodiments, an electronic registration (ER) system is provided. A point-of-sale (POS) interface is configured to receive messages from and provide messages to a POS system. An ER database is provided. ER programmed logic circuitry is configured to: receive, via the POS interface, an indication that a form of stored value has been purchased; store a record of the purchase of the form of stored value; receive an indication that the form of stored value was purchased fraudulently; flag the form of stored value as having been purchased fraudulently; and provide, when an attempt to use the form of stored value is made, a notification that the transaction should not be completed.

It will be appreciated that these aspects and embodiments may be combined in various combinations and sub-combinations to achieve yet further exemplary embodiments. Also, it will be appreciated that the exemplary embodiments herein may be implemented as any suitable combination of programmed logic circuitry including, for example, hardware, software, firmware, etc. Instructions may be stored on a suitable non-transitory computer readable storage medium and, when executed, may perform method steps corresponding to those described herein.

### BRIEF DESCRIPTION OF THE DRAWINGS

These and other features and advantages will be better and more completely understood by referring to the following detailed of exemplary illustrative non-limiting implementations in conjunction with the drawings, of which:

FIG. 1 is a schematic block diagram illustrating an example of an overall electronic product registration (ER) system that may be used in accordance with an exemplary embodiment;

FIG. 2 is a high level flowchart of some of the main steps performed in accordance with prior electronic product registration (ER) systems;

FIG. 3 is a simplified block diagram showing illustrative components of an ER system according to certain exemplary embodiments;

FIG. 4 is a flowchart showing an illustrative process for tracking and/or identifying gift cards offered as return credit according to certain exemplary embodiments; and

FIG. 5 is a flowchart showing an illustrative process for tracking and/or identifying gift cards sold through a point-of-sale (POS) location according to certain exemplary embodiments.

### DETAILED DESCRIPTION

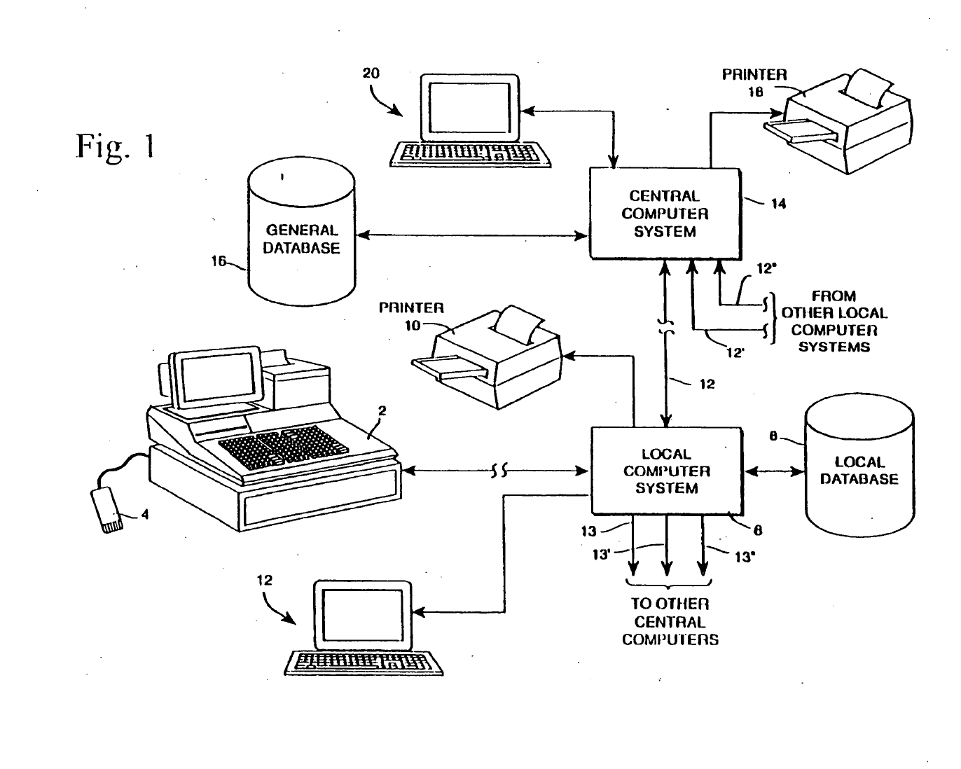

An example of one type of electronic product registration (ER) system that may be used in connection with the instant invention is illustrated in FIG. 1. Briefly, this example system includes a point of sale register 2 and an associated bar code scanner 4. The register 2 is preferably connected with a local computer system 6 in any suitable manner. In certain situations (e.g., single store retailers), it may be advantageous to have the local computer system 6 located in proximity to the register 2. For large chain stores, however, it may be advantageous to situate the local retailer computer 6 at a central location with links to the registers 2 at individual stores. The particular arrangement will depend on the preferences and circumstances of the specific retailer and may vary in accordance therewith.

The local retailer computer system includes an associated local database 8 for storing registration information. Additionally, a local printer 10 and an operator terminal 11 may be provided. The operator terminal may be used, for example, by a store clerk upon return of merchandise to locate pertinent sales information in the local database 8. The printer 10 may be used to produce hard copies of, for example, end-of-day sales reports and/or the like.

In the exemplary embodiment, a communication channel 12 is provided between the retailer computer system 6 and a central computer system 14. The central registration computer system may, for example, be an independent registration center computer system which electronically registers product transactions for a number of different retailers. In other words, the central computer system may be operated by a third-party service provider.

A general registration database 16 is associated with the central registration computer system 14 for storing transaction information from a plurality of retailer computer systems 6. Additionally, a printer 18 and an operator terminal 20 may be included with the central registration computer system 14. As discussed below in greater detail, the central registration computer system may maintain a number of data files pertaining to individual retailers, manufactures and the like. These data files include information applicable to the particular individual retailer, distributor, manufacturer or the like and are preferably maintained by that particular individual or entity. For example, a data file may contain specific return/warranty policy information applicable to that particular individual or entity.

It should be appreciated that the central computer system 14 is preferably intended to handle product registrations for a number of different manufacturers and/or other vendors. Accordingly, the general registration database may employ a structure wherein the product registrations for each participating vendor is maintained in separate areas. Alternatively, separate databases may be employed for each participating vendor. Of course, other data structures may be employed so long as the registration center is able to properly keep track of the product transaction information and particular return and/or warranty policies associated with each transaction.

As illustrated in FIG. 1, the central registration computer system 14 may have a number of additional communications links 12′, 12″, etc. for receiving information from other local computer systems. Thus, for example, a registration center may receive information from a number of different retailers. Additionally, the local computer system 6 may include a number of additional communication channels 13, 13′, 13″, etc. for connecting with other central computer systems. Accordingly, an individual retailer can electronically register products with a number of different registration databases, if desired. Furthermore, a number of communication channels 15, 15′, 15″, etc. can be provided for communications between the central registration computer system 14 and individual manufacturer computer systems and computer systems of third party service providers, law enforcement agencies and/or the like. Of course, a general access channel such as an Internet connection may also be made available for authorized access to the central computer system 14.

The electronic registration process begins when a customer brings merchandise to the register 2 for check-out. The sales clerk enters the SKU number which identifies the type of product involved in the transaction (e.g., Super Nintendo Entertainment System, Nintendo Game Boy, Nintendo N64, etc.) by, for example, scanning a UPC product code included on the product packaging. Of course, key entry or another technique for entering the SKU number may be used. Electronic registration might not be necessary for a substantial number of small commodity products (e.g., batteries, candy, diapers, etc.) that are commonly sold by retailers. Accordingly, a check may be made, based on the type of product as identified by the UPC code, to determine whether this is a product for which electronic registration is desired. If so, the store associate is prompted to enter the serial number of the individual item.

The serial number may be entered, for example, by scanning a serial number printed on the packaging. Alternatively, the serial number as it appears on the product may be scanned through a window in the packaging. This alternative ensures that the individual product is identified even if it is mispackaged. Also, repackaging of returned merchandise would be simplified. Other techniques, such as key entry, may also be used. Because the serial number is unique to each individual product, it acts as individual production identification information.

Once the serial number is entered, a check may be made to ensure that the serial number is valid. If not, the store associate is again prompted to enter the serial number. This is repeated until a valid serial number is obtained. Once the serial number is verified, a local database may be updated with the serial number information and any other necessary or desired information. At minimum, however, the local database should include an indication of the date on which the transaction took place. Other information might include the price paid, the store associate responsible for the sale, and the like.

The serial number of the individual product is preferable printed as part of a written customer transaction receipt. The serial number may be printed adjacent the description and SKU number of the registered product. Thus, it will be a simple matter to correlate serial numbers with associated products, particularly when several registered products appear on a single customer sales receipt. Of course, additional information may be printed as well.

The date of the transaction will typically be printed at either the beginning or the end of the sales receipt, but may appear anywhere on the receipt. After the serial number is printed, a check is made to determine whether sales are complete. Ordinarily, this will be based on the store associate hitting a TOTAL button on the cash register. Thereafter, the central registration computer system 14 is contacted and the general registration database 16 is updated with the transaction information.

Inasmuch as ER systems are known, further specific details regarding ER systems themselves will not be provided herein except as needed for a complete understanding of the invention. As seen from the above description of an ER system, original policies are defined for products when they are first sent to the retailer by the vendor. The ER system preferably includes the policies of both the vendor and the retailer and enables the policies of both parties to be easily and conveniently enforced.

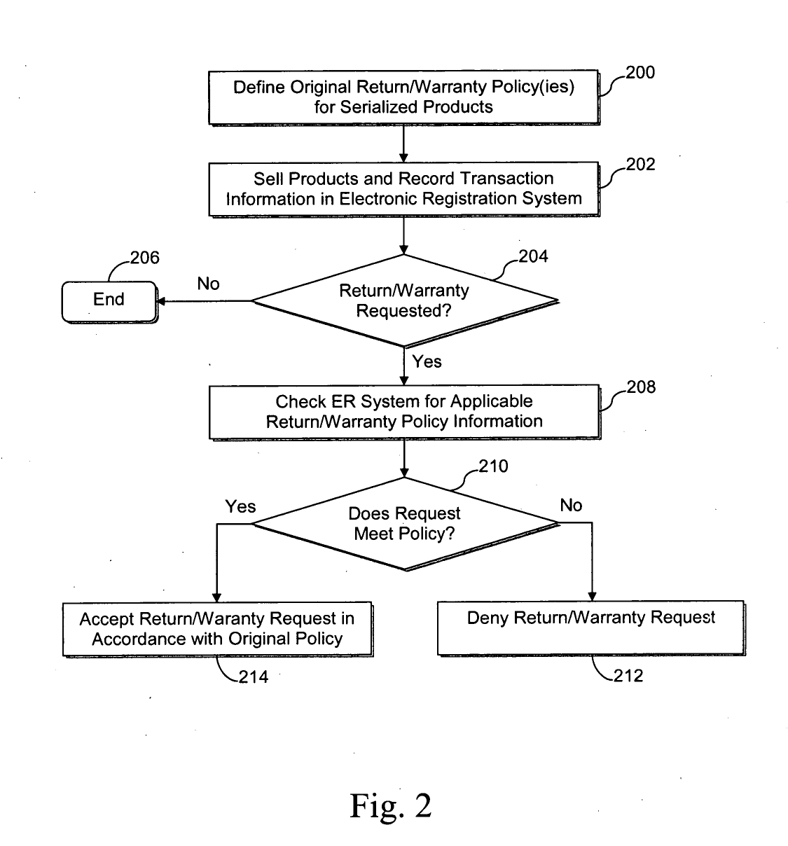

FIG. 2 shows the main steps performed in connection with conventional ER systems. As shown in FIG. 2, the return/warranty policy(ies) are defined for serialized products and entered into the ER system (step 200). The ER system uses the policies and the sales transaction information, as well as the date on which a return is requested, to determine if the product qualifies for return when presented for return. Thus, when the products are sold, the sales transaction is recorded in the ER database (step 202). If the consumer is satisfied with the product, then the process ends (step 206). On the other hand, if a return is requested (step 204), the ER system is accessed to obtain the return qualification information for the specific product being presented for return (step 208). In accordance with conventional ER systems, the return request is handled based on the return qualification information provided by the ER system based on the original policies under which the product was originally sold. Thus, based on the return qualification information provided by the ER system, a determination is made as to whether or not the product qualifies for return/warranty repair or the like (step 210). If the product does qualify for the action requested, the request can be honored by the retailer and the transaction can be completed (step 214). On the other hand, if the ER system indicates that the product does not qualify for the requested action, the customer is typically denied the return or warranty repair (step 212). Of course, the store clerk (or manager, or other titled employee) could decide, for some reason, to ignore the ER information and accept the product anyway.

As indicated above, challenges may arise in connection with fraudulent gift cards that are purchased or linked to fraudulent item returns. For instance, although stores sometimes attempt to reduce the likelihood of fraud and maintain the value of a sale and goodwill or accepting an apparently problematic item by issuing a gift card, store credit, or the like, such stores nevertheless frequently fall victim to return and gift card fraud. Although providing gift cards may sometimes alleviate some concerns about fraud, despite these protective measures, other potential fraudulent activities become possible. Certain exemplary embodiments, however, give retailers systematized control over their gift cards, potentially allowing them to track, update status, and deactivate gift card or other value means—if they are determined to be linked to fraudulent product returns or other fraudulent tender. Certain exemplary embodiments make this possible by providing unique identifiers to gift cards that can be easily tracked by a suitably configured ER system and even linked to fraudulent product returns, e.g., for items tracked by the ER system—even potentially long after the return transaction has been completed. This type of tracking is advantageous in exemplary instances where the perpetrated fraud is not immediately detected or even detectable, e.g., such that it is only discovered or even discoverable later in the supply chain and/or item lifecycle.

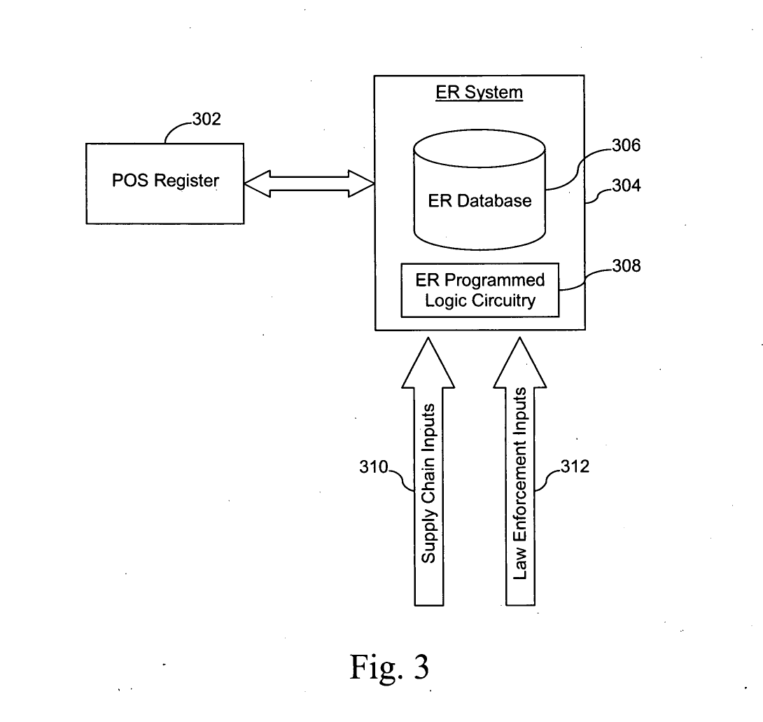

FIG. 3 is a simplified block diagram showing illustrative components of an ER system according to certain exemplary embodiments. A POS register 302 also may be provided to the location. The register 302 may be in communication with a centralized ER system 304 that includes, for example, an ER database 306 and ER programmed logic circuitry 308.

The ER system 304 also may accept inputs 310 from other points in the supply chain (e.g., from manufacturers, distributers, logistics providers, etc.). The supply chain inputs 310 may, for instance, specify the when, where, and how of item distribution, e.g., prior to arrival at a POS location. When a return or warranty is accepted by a POS location and send out (e.g., back to a manufacturer for appropriate repair, replacement, refund, etc.), the supply chain inputs 310 may specify the same or similar information. In certain exemplary embodiments, after a problem is discovered following a POS location accepting a return or warranty request, the supply chain inputs 310 may indicate that a problem has been detected. Such problems may include, for example, that the product has been damaged or tampered with (e.g., thereby voiding the warranty), the wrong product has been returned, that no product has been returned, etc.

The ER system 304 also may accept inputs 312 from law enforcement and/or other authorized agencies. In certain exemplary embodiments, the law enforcement inputs 312 may specify that a product has been flagged as lost, stolen, suspect, etc. Although the exemplary arrangement in FIG. 3 shows law enforcement inputs 312 from an external source, it will be appreciated that a crime prevention database or the like may be provided in certain exemplary embodiments. Such a crime prevention database may be separate from or integrated in whole or in part into the ER system 304. See, for example, application Ser. Nos. 12/314,150 and 12/801,677, the entire contents of which are hereby incorporated herein by reference. Active notifications also may be provided as described in, for example, application Ser. No. 12/801,677.

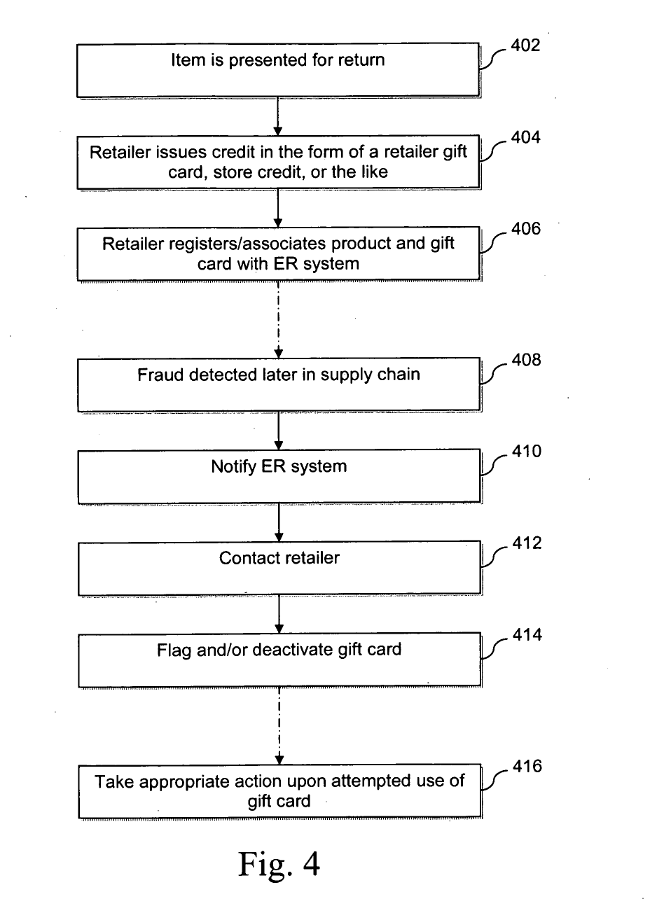

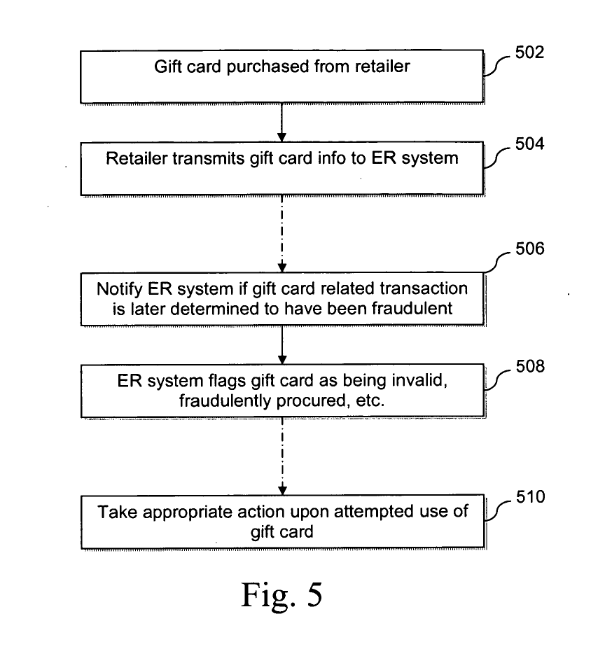

Further illustrative details of the operation of the components in from FIG. 3 and/or other system elements will be provided in connection with the exemplary flowcharts in FIGS. 4-5. In that regard, FIG. 4 is a flowchart showing an illustrative process for tracking and/or identifying gift cards offered as return credit according to certain exemplary embodiments. An item is presented for return, e.g., to a retailer, in step 402. If accepted, in step 404, the retailer issues a credit in the form of a retailer gift card, store credit, or the like.

The retailer in step 406 registers and/or associated the product and gift card with the ER system. This may in certain exemplary embodiments involve transmitting unique identifying information about the item (e.g., the serial number, UPC, EPC, etc.), along with similar information uniquely identifying the gift card. In certain illustrative implementations, a gift card database, table structure, or the like, may be maintained together with or separate from the main ER database. The gift card database may include entries with information such as, for example, the unique identifier (e.g., serial number) of the gift card, the date of issue, the original and/or current value, etc. The gift card database also may include, for example, a flag, link, or other signal to indicate that the gift card is tied to a returned item, with that particular item being uniquely identified. Transaction information may be maintained for the gift card throughout its lifecycle, e.g., as it is used to purchase items, etc. Links to and/or other identifiers for the items purchased using the gift card also may be maintained.

Later in the supply chain, at step 408, it is determined that the return was fraudulent. For example, the original purchase of the item may have been completed with fraudulent tender, the serial number on the product may have been tampered with, the product returned may have been different from the packaging, there may be a “brick-in-box” type return, etc. The ER system may be notified in step 410. This may involve, for example, transmitting the unique item identifier of the item to the ER system from the party in the supply chain (e.g., the manufacturer, wholesaler, retailer, logistics provider, etc.). The ER database may be consulted to determine the details pertaining to the return transaction. For instance, the date and/or time of the return, identity of the product being returned, transaction number, store clerk, etc., may be determined. In exemplary embodiments where the ER database also stores gift card information, the unique identifier of the gift card (and/or associated transaction details) may be obtained. In exemplary embodiments where the ER database does not directly store such information, the appropriate gift card database, table, or other structure may be consulted (e.g., using the ER programmed logic circuitry) to obtain this detail.

Once the gift card information is obtained, in step 412 the retailer may be contacted, e.g., to attempt to identify the parties involved. This may include, for example, providing information to the retailer so that the retailer can conduct its own investigation. In certain exemplary embodiments, a link to the retailer's security system may be provided so as to obtain a visual or other likeness of the suspected fraudster, a link to the payment (e.g., credit/debit card) system may be provided so as to obtain personal information about the suspected fraudster depending on the payment instrument used, etc. Similarly, in addition, or in the alternative, the authorities also may be notified.

In addition, or in the alternative, in step 414, the gift card may be flagged as being inactive and/or invalid, and/or the retailer may be notified to take corresponding action (e.g., to deactivate its eligibility). In certain exemplary embodiments, the deactivation of the card may not be made known to or visible via certain computer systems. For example, some retailers enable the value of gift cards to be monitored or checked online. The deactivation may not be made available in certain exemplary instances so that the fraudster does not know that the fraud has been detected. In so doing, the fraudster may attempt to once again use the gift card, and appropriate action may be taken as described below, e.g., in connection with step 416. In certain exemplary embodiments, when a suspected fraudster logs in to such a system, information about the login (e.g., date/time of access, IP address, unique computer information such as processor ID, MAC address, etc.) may be monitored so as to potentially help identify the suspected fraudster.

As indicated above, in step 416, an appropriate action may be taken upon the attempted use of a gift card. For example, for a retailer connected in with the ER database (e.g., via a substantially real-time, live, or establishable network connection or other computerized link), the ER system may send a notification to the retailer before the transaction is complete that the gift card is invalid, e.g., based upon a gift card eligibility table lookup. The customer may be required to pay with alternate tender in certain exemplary instances, held for questioning by the shopkeeper and/or the authorities, etc. The particular option taken here and/or elsewhere may depend, for example, upon store policy. That policy may account, for example, for the amount of information available, the likelihood that the person is a fraudster, a balance between attempting to catch fraudsters directly while attempting to avoid hassling perhaps unsuspecting accomplices who simply buy fraudulently obtained gift cards (e.g., from auctions, etc.), and/or other concerns.

As another example, for a retailer not connected with ER database, a listing of invalid gift card serial numbers may be sent (e.g., via email, fax, etc.) to the retailer from time-to-time, and store personnel may quickly check the list to determine whether the card presented is on the invalid or suspect list. The list may be sent electronically or in hardcopy (e.g., paper) form. If the list is sent electronically, it also may be checked electronically, e.g., using a computer at the POS location.

As still another example, for a retailer not connected with the ER database, when the transaction is completed using the fraudulent gift card, upon receiving the transaction record from the retailer, the ER system may immediately send an alert to the retailer AP investigative team (e.g., that the gift card was linked to a fraudulent transaction) so that the retailer may attempt to identify parties involved.

FIG. 5 is a flowchart showing an illustrative process for tracking and/or identifying gift cards sold through a point-of-sale (POS) location according to certain exemplary embodiments. A customer purchases a gift card from a cashier at a retailer POS location in step 502. In step 504, the retailer transmits the unique identifier of the gift card (e.g., serial number, UPC, EPC, etc.) to ER database for electronic registration, optionally along with any other transaction information such as, for example, date/time of transaction, transaction number, store identifier, cashier identifier, value of card, etc.

If the transaction is later determined to have been fraudulent (e.g., resulting from a bad check, a stolen credit card, etc.), the store, law enforcement, or other authorized party may notify the ER system, e.g., with the details of transaction, in step 506. In addition, or in the alternative, the reason that the transaction was fraudulent may be sent to the ER system. The ER system may then flag the gift card in the ER database as being invalid, fraudulently procured, etc., in step 508. As above, this may be done with the ER database itself, in a separate but connected gift card database, etc.

If a person attempts to use the gift card at a later time for a subsequent POS transaction, appropriate action may be taken as indicated in step 510. For instance, for a retailer connected to the ER system, a notification may be sent to the retailer before the transaction is complete, indicating that the gift card is invalid, e.g., following a gift card eligibility table lookup or the like. As above, the customer may be asked to pay with alternate tender, held for questioning, etc. As another example, for a retailer not connected to the ER system, the ER system may periodically, upon request, or otherwise send a listing of invalid gift card serial numbers to the retailer, as indicated above. The cashier at the retail location may check the list to determine whether the gift card is invalid. As still another example, for a retailer not connected with the ER database, when the transaction is completed using the fraudulent gift card, upon receiving the transaction record from the retailer, the ER system may immediately send an alert to the retailer AP investigative team (e.g., that the gift card was linked to a fraudulent transaction) so that the retailer may attempt to identify parties involved. As above, active notifications also may be provided.

In view of the illustrative techniques described above, it will be appreciated that certain exemplary embodiments may provide store and/or connect transaction information for gift cards to an ER database such that fraudulent activities associated with the gift card and/or items linked to the gift card may be tracked and/or identified—even potentially long after the gift card has been initially provided. This may advantageously help stores reduce fraudulent activities related to gift cards, which currently annually cost stores millions of dollars.

Although certain exemplary embodiments have been described as relating to gift cards, it will be appreciated that the exemplary techniques described herein may be applied to other forms of stored value. Forms of stored value include, for example, gift cards, check cards, store credit, and/or the like. In addition, although certain exemplary embodiments have been described as relating to retail point-of-sale locations, it will be appreciated that the exemplary techniques described herein may be applied to other locations. For example, the exemplary techniques described herein may be used at retail, wholesale, manufacturing, online, auction house, and/or other locations. It also will be appreciated that the ER system may be located remote from such locations in certain exemplary instances. Furthermore, in embodiments where a separate stored value database is provided, such a stored value database may be located in or with the ER system, at the POS or other location, or elsewhere. Certain exemplary embodiments have been described in connection with return requests, but the techniques described herein also may be applied to example scenarios where warranty requests are made, in addition or in the alternative.

Although certain exemplary embodiments described herein have shown and/or described messages being provided on displays, receipt tapes, and/or the like, it will be appreciated that such messages may be provided in different ways, in different formats, and/or on different media. For example, such messages may be provided on a display screen at the POS location for the customer and/or staff member, on a print-out for a POS location staff member, on a customer's receipt, etc. Additionally, although certain exemplary embodiments have been described as relating to serial numbers, it will be appreciated that the techniques described herein may be applied to products identified in different ways, e.g., by EPC, RFID, EAN, JAN, etc.

Additionally, although certain exemplary embodiments have been described in relation to products having serial numbers, the present invention is not so limited. For example, unserialized products may also take advantage of the techniques described herein by virtue of other unique and/or identifiable characteristics thereof. Furthermore, certain products are produced in such limited quantities that their mere existence may be self-authenticating and/or self-identifiable. Additionally, certain products are so tightly controlled that their appearance via other channels may indicate a potential problem worthy of notification to a trusted authority (e.g. the auction house, a manufacturer, a trusted ER intermediary, etc.).

While the systems and methods have been described in connection with what is presently considered to practical and preferred embodiments, it is to be understood that these systems and methods are not limited to the disclosed embodiments, but on the contrary, is intended to cover various modifications and equivalent arrangements included within the scope of the appended claims.

What is claimed is:

1. An electronic registration (ER) method for reducing the incidence of fraud in connection with a form of stored value in connection with an ER system comprising an ER database, the method comprising:
receiving, at the ER system, an indication that an item has been returned and that a form of stored value has been issued;
storing, in the ER database, a record of the return of the item;
storing a record of the issuance of the form of stored value;
associating the record of the issuance of the form of stored value with the record of the return of the item;
receiving, at the ER system, an indication that the item was returned fraudulently; and
flagging, via the ER system, the form of stored value using the association of the record of the issuance of the form of stored value with the record of the return of the item.

2. The method of claim 1, wherein the form of stored value is a gift card.

3. The method of claim 1, wherein the indication that the item was returned fraudulently is received from a party in the supply chain that is not the party that initially accepted the return and issued the form of stored value.

4. The method of claim 3, wherein the indication that the item was returned fraudulently is received from a manufacturer of the item.

5. The method of claim 4, wherein the party that initially accepted the return and issued the form of stored value is a retailer.

6. The method of claim 3, wherein the party that initially accepted the return and issued the form of stored value is a retailer, and further comprising:
notifying the retailer to deactivate the form of stored value.

7. The method of claim 1, further comprising when an attempt to use the form of stored value is made, providing a notification that the transaction should not be completed.

8. An electronic registration (ER) method for reducing the incidence of fraud in connection with a form of stored value in connection with an ER system comprising an ER database, the method comprising:
receiving, at the ER system, an indication that a form of stored value has been purchased;
storing a record of the purchase of the form of stored value;
receiving, at the ER system, an indication that the form of stored value was purchased fraudulently;
flagging, via the ER system, the form of stored value as having been purchased fraudulently; and
when an attempt to use the form of stored value is made, providing a notification that the transaction should not be completed.

9. The method of claim 8, wherein the form of stored value is a gift card.

10. The method of claim 8, wherein the indication that the form of stored value was purchased fraudulently is received from the location from which the form of stored value was purchased.

11. The method of claim 8, wherein the indication that the form of stored value was purchased fraudulently is received from a law enforcement agency.

12. The method of claim 8, further comprising notifying the retailer to deactivate the form of stored value.

13. An electronic registration (ER) system, comprising:
a point-of-sale (POS) interface configured to receive messages from and provide messages to a POS system;
an ER database; and
ER programmed logic circuitry configured to:
receive, via the interface, an indication that an item has been returned and that a form of stored value has been issued,
store, in the ER database, a record of the return of the item,
associate a previously-stored record of the issuance of the form of stored value with the record of the return of the item,
receive an indication that the item was returned fraudulently, and
flag the form of stored value using the association of the record of the issuance of the form of stored value with the record of the return of the item.

14. The system of claim 13, wherein the form of stored value is a gift card.

15. The system of claim 13, further comprising a supply chain interface configured to receive messages from and provide messages to parties involved in the lifecycle of the item.

16. The system of claim 15, wherein the indication that the item was returned fraudulently is received from a party in the supply chain that is not the party that initially accepted the return and issued the form of stored value.

17. The system of claim 16, wherein the ER programmed logic circuitry is further configured to notify the retailer to deactivate the form of stored value via the POS interface.

18. The system of claim 13, wherein the ER programmed logic circuitry is further configured to send, when an attempt to use the form of stored value is made, a notification that the transaction should not be completed.

19. An electronic registration (ER) system, comprising:
a point-of-sale (POS) interface configured to receive messages from and provide messages to a POS system;
an ER database; and
ER programmed logic circuitry configured to:
receive, via the POS interface, an indication that a form of stored value has been purchased,
store a record of the purchase of the form of stored value,
receive an indication that the form of stored value was purchased fraudulently,
flag the form of stored value as having been purchased fraudulently, and
provide, when an attempt to use the form of stored value is made, a notification that the transaction should not be completed.

20. The system of claim 19, wherein the form of stored value is a gift card.

21. The system of claim 19, wherein the indication that the form of stored value was purchased fraudulently is received from the location from which the form of stored value was purchased via the POS interface.

22. The system of claim 19, further comprising a law enforcement interface configured to receive messages from and provide messages to law enforcement agencies.

23. The system of claim 19, wherein the ER programmed logic circuitry is further configured to send a notification that the form of stored value should be deactivated.
